(19) United States
(12) Patent Application Publication
(10) Pub. No.: US 2009/0310577 A1
(43) Pub. Date: Dec. 17, 2009

(54) WIRELESS LAN SYSTEM AND WIRELESS LAN ACCESS POINT

(76) Inventor: Shinji Kiribayashi, Tokyo (JP)

Correspondence Address: Mr. Jackson Chen, 6535 N. STATE HWY 161, IRVING, TX, 75039, US

(21) Appl. No.: 12/307,647

(22) PCT Filed: Jun. 15, 2007
(86) PCT No.: PCT/JP2007/062115

§ 371 Date: Jan. 6, 2009

(30) Foreign Application Priority Data
Jul. 13, 2006 (JP) 2006-192878

(51) Int. Cl. H04W 84/12

(52) U.S. Cl. 370/338

(57) ABSTRACT

A wireless LAN system of the present invention is provided with a wireless LAN client terminal (40) and a wireless LAN access point (10) which performs wireless communication with the wireless LAN client terminal (40) to connect the wireless LAN client terminal (40) to an external network, and the wireless LAN access point (10) is attached to a lighting apparatus.

### TECHNICAL FIELD

This application claims priority based on Japanese Patent Application No. 2006-192878 filed on Jul. 13, 2006, all of the disclosure of which is incorporated herein.

The present invention relates to a wireless LAN system and a wireless LAN access point.

### BACKGROUND ART

Recently, it has been common to construct wireless LAN systems in general homes.

Generally, in a wireless LAN system, a wireless LAN access point performs wireless communication with a LAN client terminal, which is a personal computer or the like, to connect the wireless LAN client terminal to an external network. The wireless LAN access point connects to the external network directly or via a router.

For example, power line communication using a power line as a communication line can be used for making a connection between the wireless LAN access point and the external network (see Patent Document 1).

However, as shown in FIG. 1, since it is necessary that common wireless LAN access point 100 be connected to a power source connection unit (receptacle) and be connected to external network 30 directly or via router 20, its installation place is restricted to a corner of a room or the like.

When wireless LAN access point 100 is installed in the corner of a room as described above, the range of emission of radio waves is narrow. Furthermore, since the range of emission of radio waves is narrow, the receiving sensitivity of wireless LAN client terminal 40 deteriorates if there is a physical obstacle in the way. Patent Document 1: Japanese Patent Laid-Open No. 2001-244940

### DISCLOSURE OF THE INVENTION

Accordingly, the object of the present invention is to provide a wireless LAN access system and a wireless LAN access point which are capable of emitting radio waves across a wide range of ratio wavelength.

In order to achieve the above object, the wireless LAN system of the present invention is a wireless LAN system comprising a wireless LAN client terminal and a wireless LAN access point which performs wireless communication with the wireless LAN client terminal to connect the wireless LAN client terminal to an external network, the wireless LAN system being characterized in that: the wireless LAN access point is attached to a lighting apparatus.

In order to achieve the above object, the wireless LAN access point of the present invention is a wireless LAN access point which performs wireless communication with a wireless LAN client terminal to connect the wireless LAN client terminal to an external network, the wireless LAN access point being characterized that the wireless LAN access point is attached to a lighting apparatus.

As described above, according to the present invention, a wireless LAN access point is configured to be attached to a lighting apparatus.

When installed indoors, a lighting apparatus is usually installed at the upper center of a room, for example, on the ceiling, so that the light reaches over the whole room.

Therefore, it is advantageous that radio waves from the wireless LAN access point can also be widely emitted over the range where the light of the lighting apparatus reaches.

### BRIEF DESCRIPTION OF THE DRAWINGS

FIG. 1 is a diagram showing an example of the arrangement of a common wireless LAN system;

FIG. 2 is a diagram showing an example of the arrangement of a wireless LAN system according to a first exemplary embodiment;

FIG. 3 is a diagram showing an example of the configuration around a wireless LAN access point in the wireless LAN system shown in FIG. 2;

FIG. 4 is a diagram showing another example of the configuration around the wireless LAN access point in the wireless LAN system shown in FIG. 2;

FIG. 5 is a diagram showing still another example of the configuration around the wireless LAN access point in the wireless LAN system shown in FIG. 2;

FIG. 6 is a diagram showing an example of how to install the wireless LAN access point shown in FIG. 2 to a lighting apparatus;

FIG. 7 is a diagram showing another example of how to install the wireless LAN access point shown in FIG. 2 to a lighting apparatus;

FIG. 8 is a diagram showing still another example of how to install the wireless LAN access point shown in FIG. 2 to a lighting apparatus;

FIG. 9 is a diagram showing a further different example of how to install the wireless LAN access point shown in FIG. 2 to a lighting apparatus;

FIG. 10 is a diagram showing a still further different example of how to install the wireless LAN access point shown in FIG. 2 to a lighting apparatus;

FIG. 11A is a diagram showing an example of how to connect the wireless LAN access point shown in FIG. 2 to an external network;

FIG. 11B is a diagram showing an example of how to connect the wireless LAN access point shown in FIG. 2 to an external network;

FIG. 12A is a diagram showing another example of how to connect the wireless LAN access point shown in FIG. 2 to an external network;

FIG. 12B is a diagram showing another example of how to connect the wireless LAN access point shown in FIG. 2 to an external network;

FIG. 13 is a diagram showing still another example of how to connect the wireless LAN access point shown in FIG. 2 to an external network;

FIG. 14A is a diagram showing an example of how to install the wireless LAN access point shown in FIG. 2 indoors;

FIG. 14B is a diagram showing an example of how to install the wireless LAN access point shown in FIG. 2 indoors;

FIG. 15A is a diagram showing another example of how to install the wireless LAN access point shown in FIG. 2 indoors;

FIG. 15B is a diagram showing another example of how to install the wireless LAN access point shown in FIG. 2 indoors;

FIG. 16 is a diagram showing still another example of how to install the wireless LAN access point shown in FIG. 2 indoors;

FIG. 17 is a diagram showing an example of the operation of the wireless LAN system shown in FIG. 2;

FIG. 18 is a diagram showing an example of how to install the wireless LAN access point shown in FIG. 2 outdoors;

FIG. 19 is a diagram showing an example of the configuration around a wireless LAN access point in a wireless LAN system of a second exemplary embodiment;

FIG. 20 is a diagram showing an example of the configuration around a wireless LAN access point in a wireless LAN system of a third exemplary embodiment; and

FIG. 21 is a diagram showing an example of the configuration around a wireless LAN access point in a wireless LAN system of a fourth exemplary embodiment.

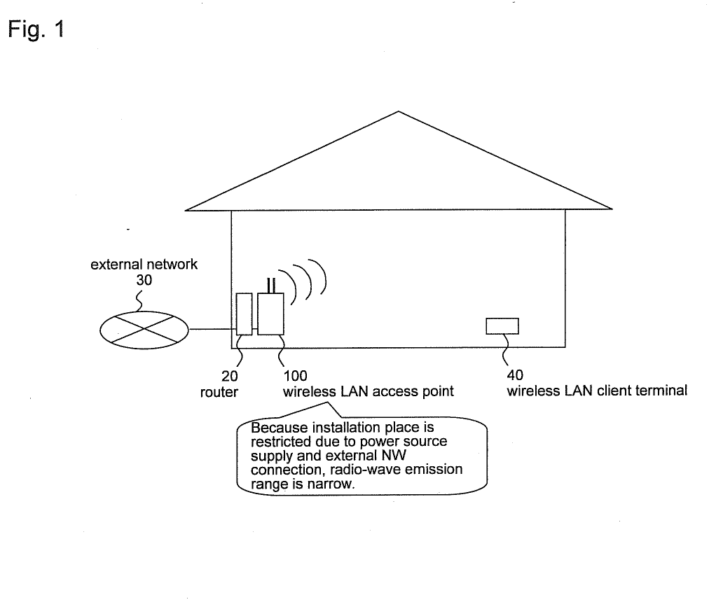

### BEST MODE FOR CARRYING OUT THE INVENTION

Exemplary embodiments for carrying out the present invention will be described below with reference to drawings.

### First Exemplary Embodiment

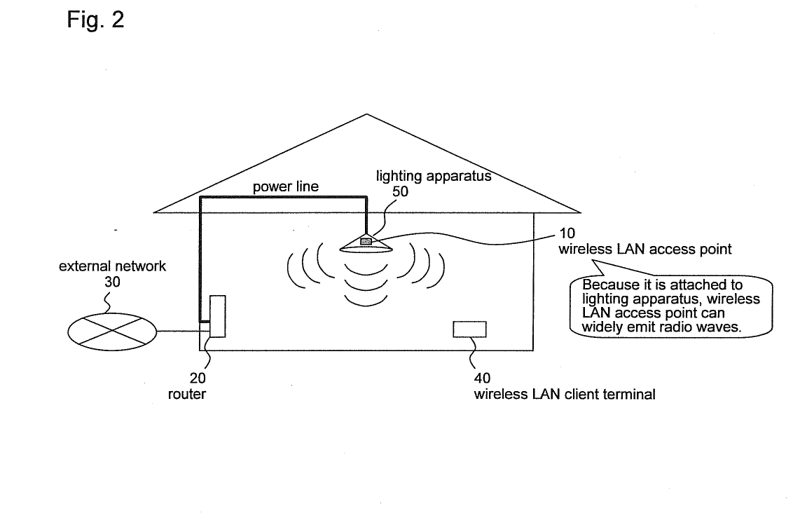

FIG. 2 is a diagram showing an example of the arrangement of a wireless LAN system according to a first exemplary embodiment.

As shown in FIG. 2, wireless LAN access point 10 is attached to lighting apparatus 50 in the wireless LAN system of this exemplary embodiment.

When installed indoors, lighting apparatus 50 is usually installed at the upper center of a room, for example, on the ceiling, so that the light reaches over the whole room. Therefore, it is possible to widely emit radio waves from wireless LAN access point 10 over the range where the light of lighting apparatus 50 reaches.

Wireless LAN access point 10 receives power source supply via a power line which is drawn to the ceiling and from which lighting apparatus 50 receives a power source supply.

Wireless LAN access point 10 connects to external network 30 by performing communication with external network 30 directly or via router 20.

Though FIG. 2 shows an example of using power line communication for which a power line drawn to the ceiling is used as a communication line for making a connection between wireless LAN access point 10 and external network 30, the present invention is not limited thereto. Wireless communication or conventional network communication using a network cable, such as Ethernet, may be used.

In the case of using wireless communication or power line communication for making a connection between wireless LAN access point 10 and external network 30, among these cases, it is not necessary to provide new wiring on the wall and the ceiling, and therefore, it is possible to easily install wireless LAN access point 10 without necessity of wiring work.

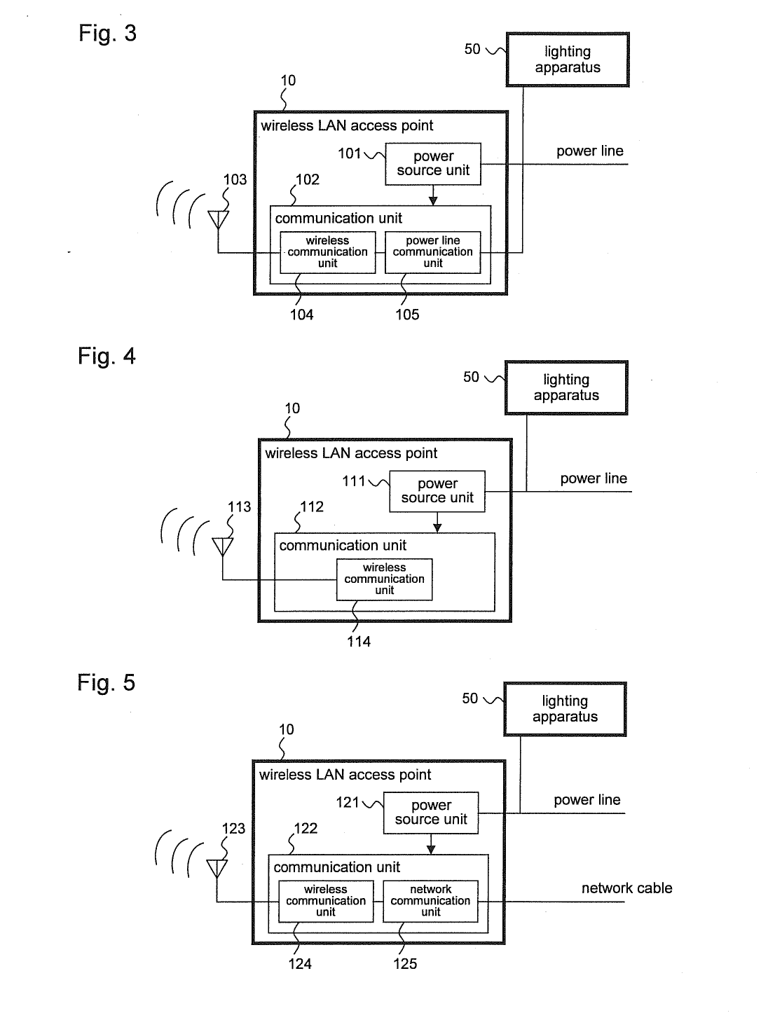

FIG. 3 is a diagram showing an example of the configuration around wireless LAN access point 10 in the wireless LAN system shown in FIG. 2.

Wireless LAN access point 10 shown in FIG. 3 is configured to use power line communication for making a connection to external network 30, and it has power source unit 101, communication unit 102 and antenna 103. Communication unit 102 has wireless communication unit 104 and power line communication unit 105. In FIG. 3, units unrelated to the present invention are omitted.

Power source unit 101 receives power source supply via a power line drawn to the ceiling and supplies the power source to communication unit 102.

Wireless communication unit 104 performs wireless communication with wireless LAN client terminal 40 via antenna 103. Power line communication unit 105 performs power line communication with external network 30 or router 20 via the power line drawn to the ceiling. Thereby, it is possible to connect wireless LAN access point 10 and external network 30 directly or via router 20.

FIG. 4 is a diagram showing another example of the configuration around wireless LAN access point 10 in the wireless LAN system shown in FIG. 2.

Wireless LAN access point 10 shown in FIG. 4 is configured to use wireless communication for making a connection to external network 30, and it has power source unit 111, communication unit 112 and antenna 113. Communication unit 112 has wireless communication unit 114. In FIG. 4, units unrelated to the present invention are omitted.

Power source unit 111 receives power source supply via a power line drawn to the ceiling and supplies the power source to communication unit 112.

Wireless communication unit 114 performs wireless communication with wireless LAN client terminal 40 via antenna 113. Furthermore, wireless communication unit 114 performs wireless communication with external network 30 or router 20 via antenna 113. Thereby, it is possible to connect wireless LAN access point 10 and external network 30 directly or via router 20.

FIG. 5 is a diagram showing still another example of the configuration around wireless LAN access point 10 in the wireless LAN system shown in FIG. 2.

Wireless LAN access point 10 shown in FIG. 5 is configured to use network communication for making a connection to external network 30, and it has power source unit 121, communication unit 122 and antenna 123. Communication unit 122 has wireless communication unit 124 and network communication unit 125. In FIG. 5, units unrelated to the present invention are omitted.

Power source unit 121 receives power source supply via a power line drawn to the ceiling and supplies the power source to communication unit 122.

Wireless communication unit 124 performs wireless communication with wireless LAN client terminal 40 via antenna 123. Furthermore, network communication unit 125 performs network communication, such as Ethernet communication, with external network 30 or router 20 via a network cable. Thereby, it is possible to connect wireless LAN access point 10 and external network 30 directly or via router 20.

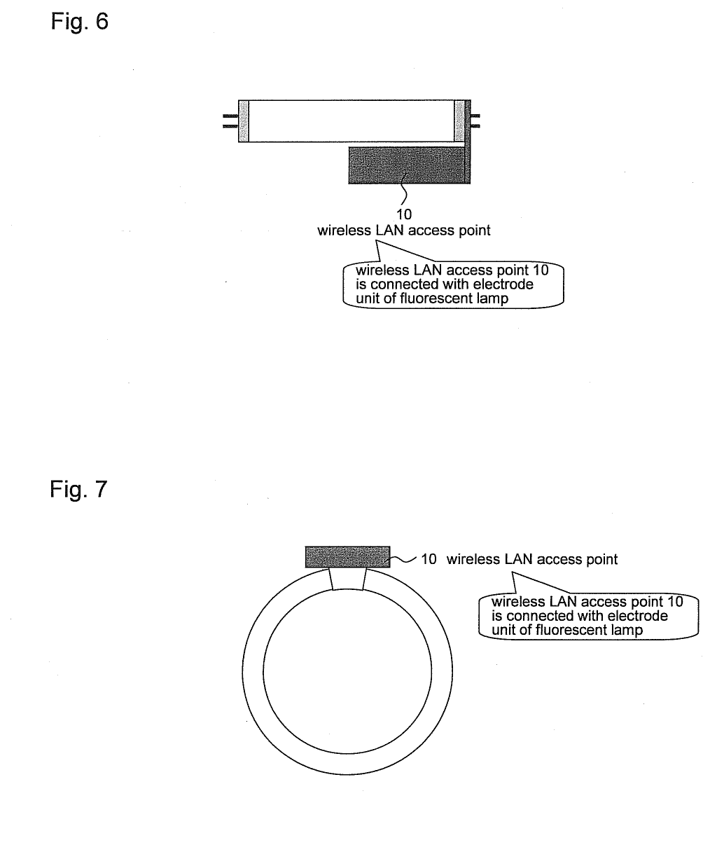

Here, description will be made on how to install wireless LAN access point 10 to lighting apparatus 50, with reference to FIGS. 6 to 10.

In the example shown in FIG. 6, wireless LAN access point 10 is connected to the electrode unit of a rod-shaped fluorescent lamp of lighting apparatus 50.

In the example shown in FIG. 7, wireless LAN access point 10 is connected to the electrode unit of a doughnut-shaped fluorescent lamp of lighting apparatus 50.

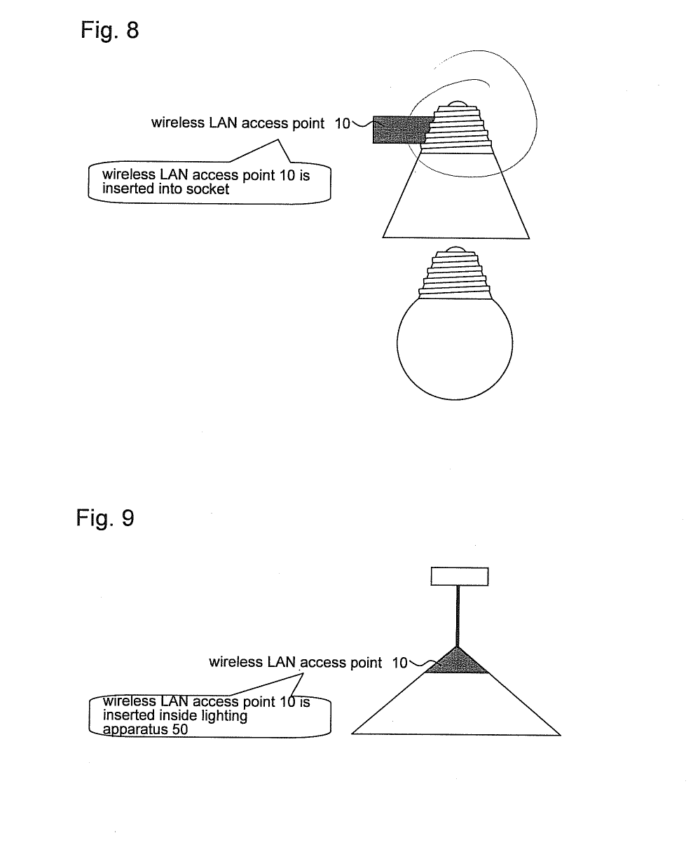

In the example shown in FIG. 8, wireless LAN access point 10 is inserted in a socket for a light bulb or spherical shaped fluorescent lamp of lighting apparatus 50 and is connected with the connection unit of the socket to be connected with a light bulb or a fluorescent lamp.

In the example shown in FIG. 9, wireless LAN access point 10 is inserted inside lighting apparatus 50 and connected with the connection unit of the socket to be connected with a light bulb or a fluorescent lamp.

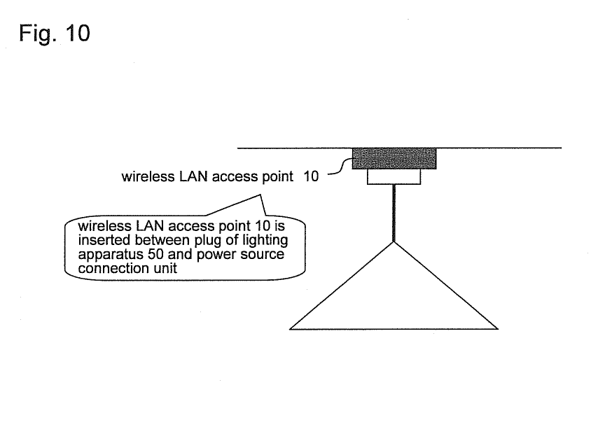

In the example shown in FIG. 10, wireless LAN access point 10 is inserted between the plug of lighting apparatus 50 and a power source connection unit (receptacle) and connected with the connection unit between the plug and the power source connection unit.

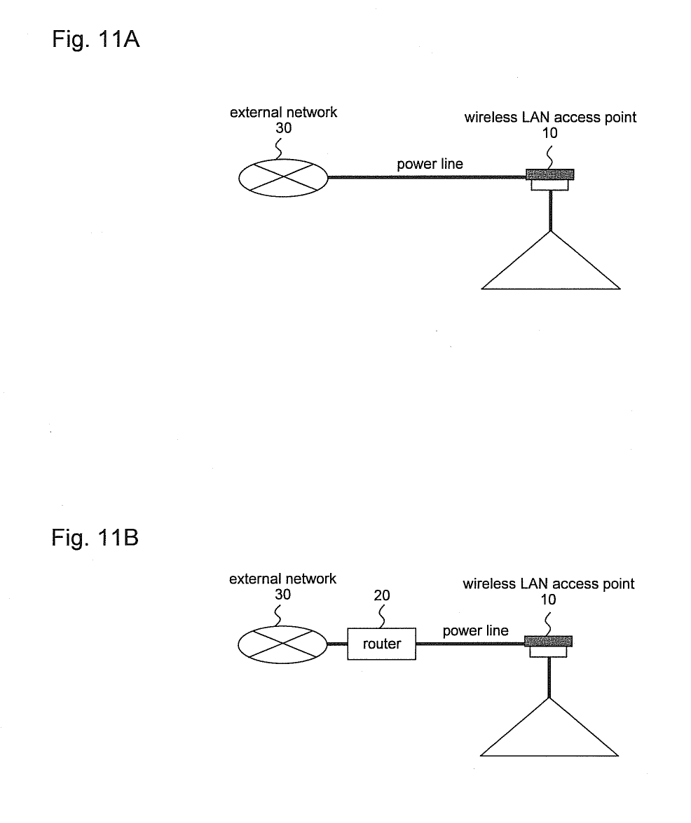

Next, description will be made on how to connect wireless LAN access point 10 and external network 30 with reference to FIGS. 11A to 13. In FIGS. 11A to 13, it is assumed that wireless LAN access point 10 is inserted between the plug of lighting apparatus 50 and the power source connection unit and attached, as shown in FIG. 10.

In the examples shown in FIGS. 11A and 11B, power line communication is used for making a connection between wireless LAN access point 10 and external network 30. In FIG. 11A, power line communication is directly used for making a connection between wireless LAN access point 10 and external network 30. In FIG. 11B, power line communication is used for making a connection between wireless LAN access point 10 and router 20. For making a connection between router 20 and external network 30, a conventional communication method, for example, wired communication via an optical cable, a telephone line or a cable or wireless communication by a wireless LAN using a different frequency band or by WiMAX (Worldwide Interoperability for Microwave Access) is used.

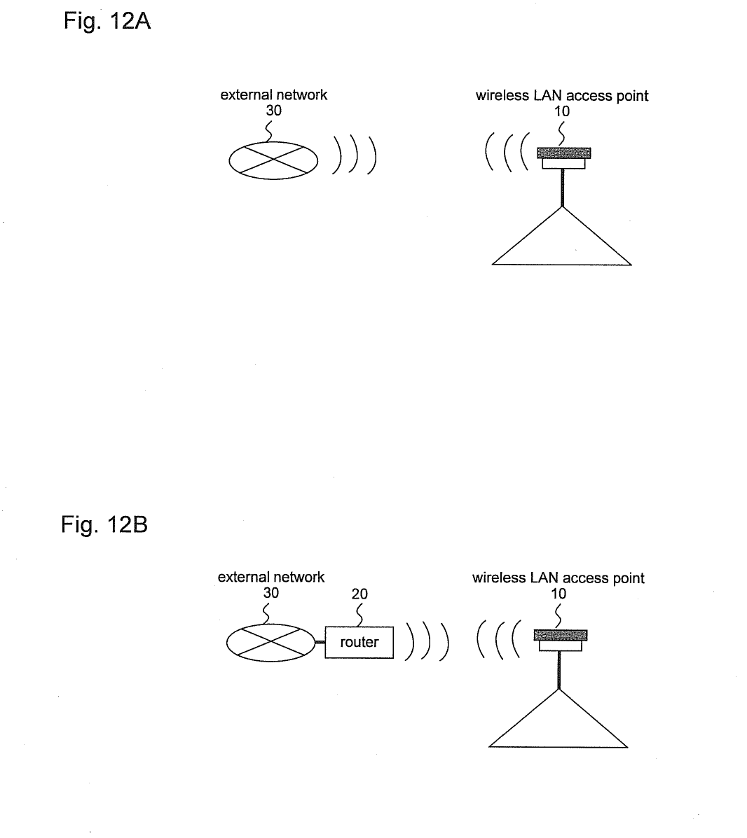

In the examples shown in FIGS. 12A and 12B, wireless communication is used for making a connection between wireless LAN access point 10 and external network 30. In FIG. 12A, wireless communication is directly used for making a connection between wireless LAN access point 10 and external network 30. For example, wireless communication by a wireless LAN using a different frequency band or by WiMAX is used. In FIG. 12B, wireless communication is used for making a connection between wireless LAN access point 10 and router 20. For example, wireless communication by a wireless LAN using a different frequency band or by WiMAX is used. For making a connection between router 20 and external network 30, a conventional communication method, for example, wired communication via an optical cable, a telephone line or a cable or wireless communication using a wireless LAN by a different frequency band or by WiMAX is used.

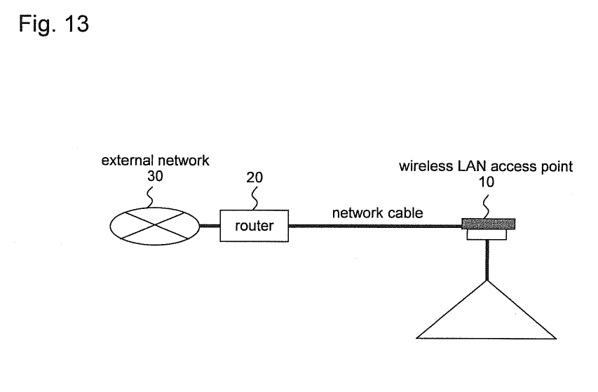

In the example shown in FIG. 13, network communication is used for making a connection between wireless LAN access point 10 and external network 30. Specifically, conventional network communication, such as Ethernet communication, using a network cable is used for making a connection between wireless LAN access point 10 and router 20, and a conventional communication method, for example, wired communication via an optical cable, a telephone line or a cable, or wireless communication by a wireless LAN using a different frequency band or by WiMAX is used for making a connection between router 20 and external network 30.

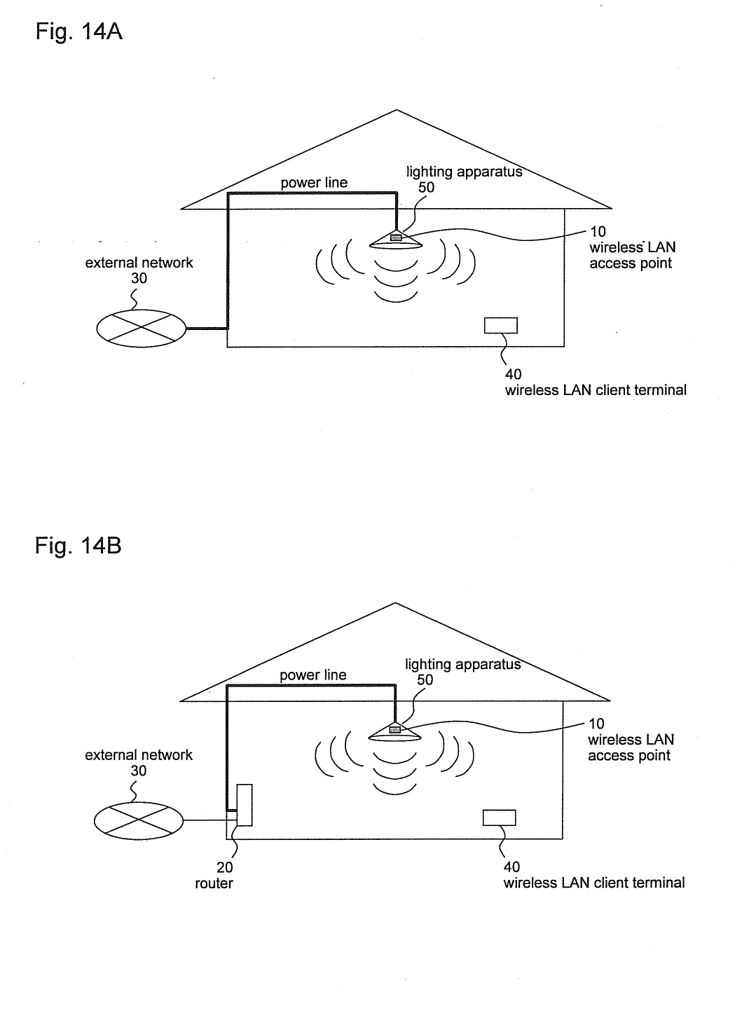

Next, description will be made on how to install wireless LAN access point 10 indoors, with reference to FIGS. 14A to 16.

In the examples shown in FIGS. 14A and 14B, wireless LAN access point 10 is installed indoors in the methods shown in FIGS. 11A and 11B. In FIG. 14A, wireless LAN access point 10 uses power line communication to directly connect to external network 30. In FIG. 14B, wireless LAN access point 10 uses power line communication, and uses router 20 to connect to external network 30.

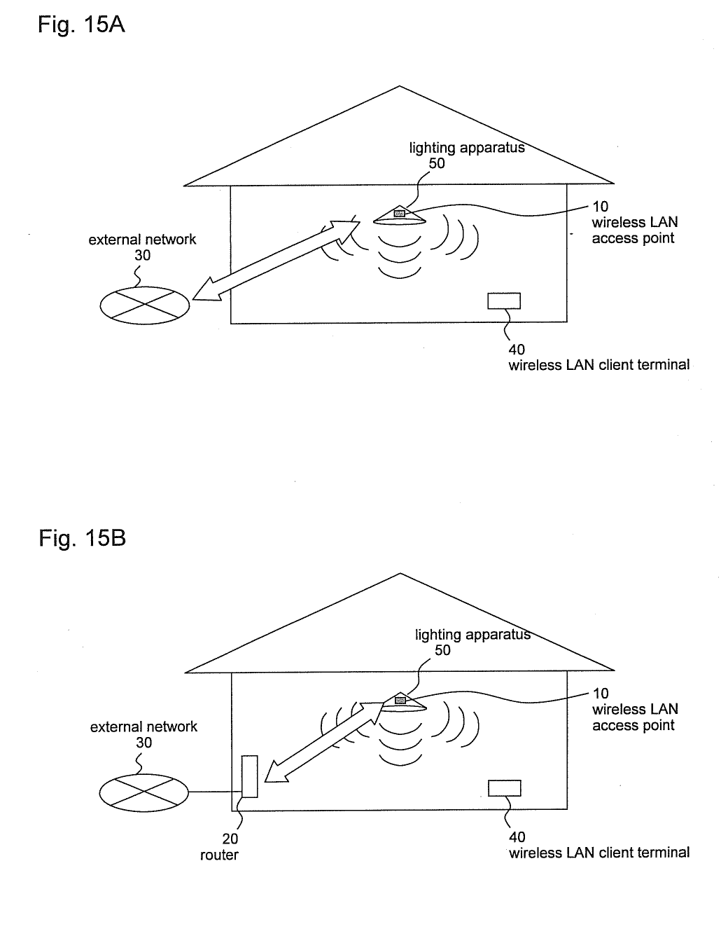

In the examples shown in FIGS. 15A and 15B, wireless LAN access point 10 is installed indoors in the methods shown in FIGS. 12A and 12B. In FIG. 15A, wireless LAN access point 10 uses wireless communication to directly connect to external network 30. In FIG. 15B, wireless LAN access point 10 uses wireless communication, and uses router 20 to connect to external network 30.

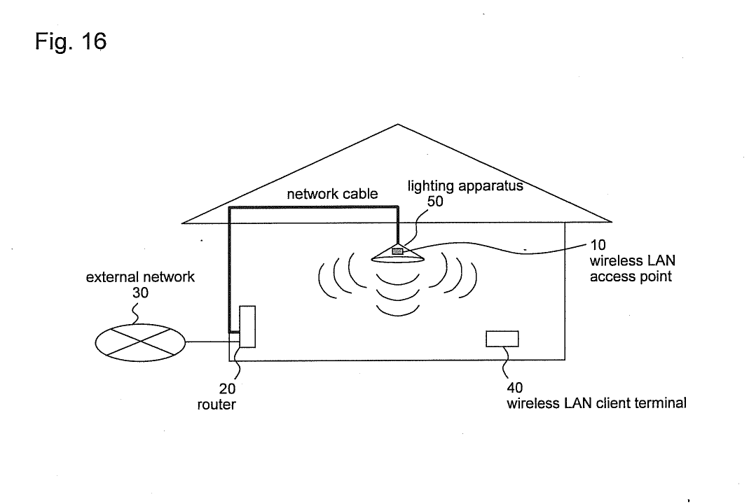

In the example shown in FIG. 16, wireless LAN access point 10 is installed indoors in the method shown in FIG. 13. Specifically, wireless LAN access point 10 uses network communication, and uses router 20 to connect to external network 30.

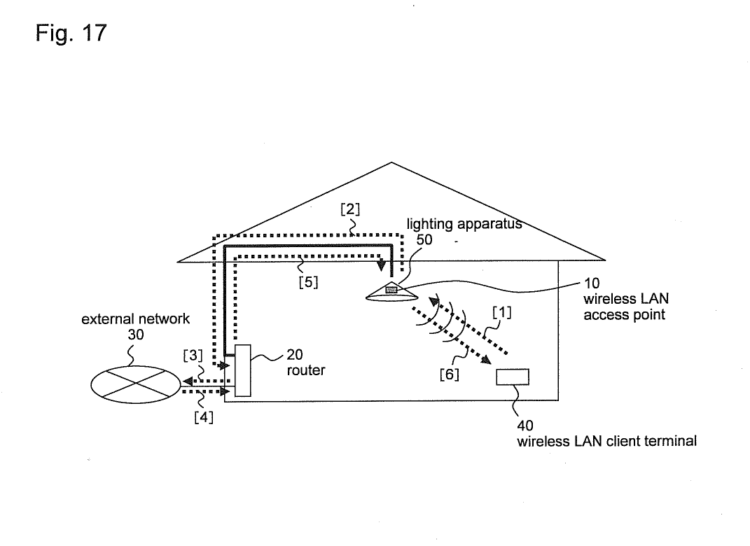

Now, description will be made on the operation of the wireless LAN system of this exemplary embodiment with reference to FIG. 17. In FIG. 17, it is assumed that wireless LAN access point 10 is installed as in FIG. 14B.

[1] Wireless LAN client terminal 40 transmits data to wireless LAN access point 10 attached to lighting apparatus 50, using wireless communication.

[2] Next, wireless LAN access point 10 transmits the data transmitted from wireless LAN client terminal 40 to router 20, using power line communication.

[3] Next, router 20 transmits the data transmitted from wireless LAN access point 10 to external network 30.

[4] Router 20 receives the data from external network 30.

[5] Next, router 20 transmits the data received from external network 30 to wireless LAN access point 10 attached to lighting apparatus 50, using power line communication.

[6] After that, wireless LAN access point 10 transmits the data received from router 20 to wireless LAN client terminal 40, using wireless communication.

As described above, according to this exemplary embodiment, it is possible to widely emit radio waves from wireless LAN access point 10 over the range where the light of lighting apparatus 50 reaches, due to the configuration in which wireless LAN access point 10 is attached to lighting apparatus 50.

Furthermore, in the case of using wireless communication or power line communication for making a connection between wireless LAN access point 10 and external network 30, it is possible to easily install wireless LAN access point 10 without performing works such as the work for new wiring.

In this exemplary embodiment, an example of installing wireless LAN access point 10 outdoors has been described. However, wireless LAN access point 10 can be also installed outdoors for public services and the like.

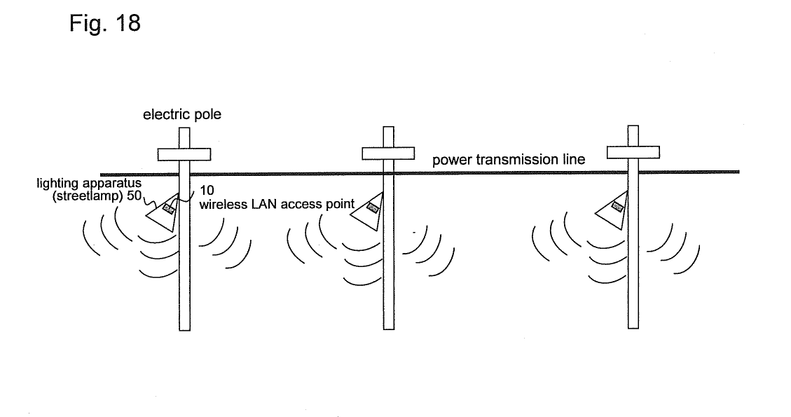

For example, as shown in FIG. 18, wireless LAN access point 10 is attached to lighting apparatus 50 which is a streetlamp of electric pole on a roadside. For communication between wireless LAN access point 10 and router 20 not shown or external network 30, power line communication is used for which a power transmission line is used as a communication line.

Thereby, it is possible to widen the access range of a wireless LAN.

### Second Exemplary Embodiment

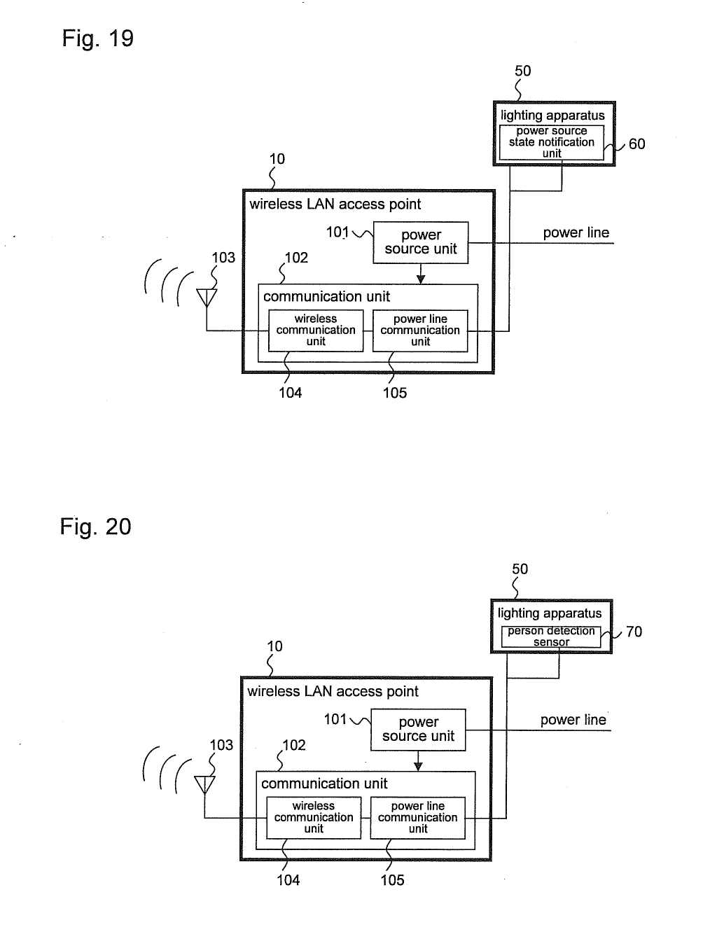

FIG. 19 is a diagram showing an example of the configuration around wireless LAN access point 10 in a wireless LAN system of a second exemplary embodiment. It is assumed that the wireless LAN system shown in FIG. 19 uses power line communication for making a connection between wireless LAN access point 10 and external network 30. In FIG. 19, the same reference numerals are given to units similar to the units in FIG. 3, and the configuration of the part other than the units shown in FIG. 19 is similar to the configuration in the first exemplary embodiment.

As shown in FIG. 19, when compared to the configuration shown in FIG. 3, the wireless LAN system of this exemplary embodiment is different in that power source state notification unit 60 is attached to lighting apparatus 50.

Power source state notification unit 60 monitors the on/off state of the power source of lighting apparatus 50 and notifies the power source state of lighting apparatus 50 to wireless LAN access point 10. The way to make the notification to wireless LAN access point 10 is arbitrary. For example, power line communication can be used. Power source state notification unit 60 may be such that it is connected to the power source unit (not shown) of lighting apparatus 50 and directly monitors the power source unit, or it may be an optical sensor which detects the light of lighting apparatus 50.

Power source unit 101 controls power source supply to communication unit 102 according to the power source state of lighting apparatus 50 notified from power source state notification unit 60. For example, power source unit 101 supplies power source to communication unit 102 if the power source of lighting apparatus 50 is in the on state, and stops power source supply to communication unit 102 if the power source is in the off state. Furthermore, power source unit 101 can include a timer and can stop power source supply to communication unit 102 when a predetermined time elapses after the power source of lighting apparatus 50 changes from the on state to the off state.

As described above, in this exemplary embodiment, it is possible to turn on/off wireless LAN access point 10 according to the on/off state of the power source of lighting apparatus 50. Therefore, it is possible to automatically turn off wireless LAN access point 10 when the power source of lighting apparatus 50 is turned off.

In this exemplary embodiment, description has been made of the case where the present invention is applied to a wireless LAN system using power line communication for making a connection between wireless LAN access point 10 and external network 30, as an example. However, the present invention is not limited thereto. It goes without saying that the present invention is applicable to a wireless LAN using wireless communication or network cable communication.

### Third Exemplary Embodiment

FIG. 20 is a diagram showing an example of the configuration around wireless LAN access point 10 in a wireless LAN system of a third exemplary embodiment. It is assumed that the wireless LAN system shown in FIG. 20 uses power line communication for making a connection between wireless LAN access point 10 and external network 30. In FIG. 20, the same reference numerals are given to units similar to the unit in FIG. 3, and the configuration of the part other than the units shown in FIG. 20 is similar to the configuration in the first exemplary embodiment.

As shown in FIG. 20, when compared to the configuration shown in FIG. 3, the wireless LAN system of this exemplary embodiment is different in that person detection sensor 70 is attached to lighting apparatus 50.

Person detection sensor 70 is a sensor which detects the presence of a person. When detecting the presence of a person, person detection sensor 70 notifies a detection signal to wireless LAN access point 10. The way to make the notification to wireless LAN access point 10 is arbitrary. For example, power line communication can be used. The type of person detection sensor is not especially limited. For example, an infrared sensor can be used which detects the presence of a person, when it emits light from a light-emitting device, and which then receives the light which has hit a person and which is reflected by a light-receiving device.

Power source unit 101 controls power source supply to communication unit 102 according to whether or not a detection signal has been notified from person detection sensor 70. For example, power source unit 101 can supply a power source to communication unit 102 when a detection signal has been notified from person detection sensor 70.

As described above, in this exemplary embodiment, it is possible to turn on/off wireless LAN access point 10 according to whether or not the presence of a person has been detected. Therefore, it is possible to automatically turn on wireless LAN access point 10 when a person is present.

In this exemplary embodiment, description has been made on the case where the present invention is applied to a wireless LAN system using power line communication for making a connection between wireless LAN access point 10 and external network 30, as an example. However, the present invention is not limited thereto. It goes without saying that the present invention is applicable to a wireless LAN using wireless communication or network cable communication.

### Fourth Exemplary Embodiment

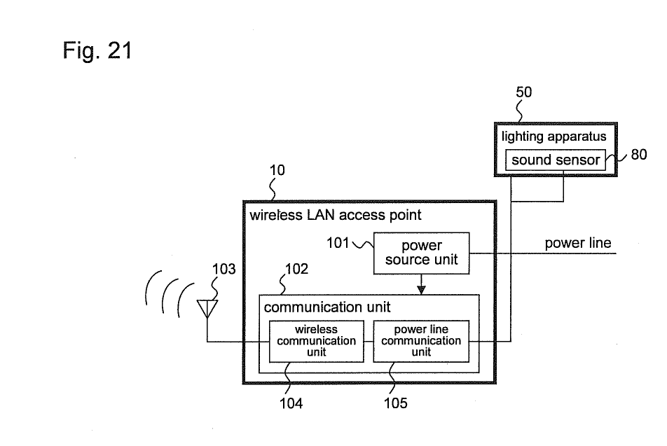

FIG. 21 is a diagram showing an example of the configuration around wireless LAN access point 10 in a wireless LAN system of a fourth exemplary embodiment. It is assumed that the wireless LAN system shown in FIG. 21 uses power line communication for making a connection between wireless LAN access point 10 and external network 30. In FIG. 21, the same reference numerals are given to units similar to the unit in FIG. 3, and the configuration of the part other than the units shown in FIG. 21 is similar to the configuration in the first exemplary embodiment.

As shown in FIG. 21, when compared to the configuration shown in FIG. 3, the wireless LAN system of this exemplary embodiment is different in that sound sensor 80 is attached to lighting apparatus 50.

Sound sensor 80 is a sensor for detecting a sound. When detecting a sound, sound sensor 80 notifies a detection signal to wireless LAN access point 10. The way to make the notification to wireless LAN access point 10 is arbitrary. For example, power line communication can be used.

Power source unit 101 controls power source supply to communication unit 102 according to whether or not a detection signal has been notified from sound sensor 80. For example, power source unit 101 can supply a power source to communication unit 102 when a detection signal has been notified from sound sensor 80.

As described above, in this exemplary embodiment, it is possible to turn on/off wireless LAN access point 10 according to whether or not a sound has been detected. Therefore, it is possible to automatically turn on wireless LAN access point 10 when a person makes a sound.

In this exemplary embodiment, description has been made of the case where the present invention is applied to a wireless LAN system using power line communication for making a connection between wireless LAN access point 10 and external network 30, as an example. However, the present invention is not limited thereto. It goes without saying that the present invention is applicable to a wireless LAN using wireless communication or network cable communication.

1. A wireless LAN system comprising a wireless LAN client terminal and a wireless LAN access point which perform wireless communication with the wireless LAN client terminal to connect the wireless LAN client terminal to an external network, the wireless LAN system being characterized in that:
the wireless LAN access point is attached to a lighting apparatus.

2. The wireless LAN system according to claim 1, characterized in that the wireless LAN access point receives a power source supply via a power line from which the lighting apparatus receives a power source supply.

3. The wireless LAN system according to claim 2, characterized in that the wireless LAN access point comprises:
a communication unit including a wireless communication unit which performs wireless communication with the wireless LAN client terminal and a power line communication unit which performs power line communication with the external network or a router connected to the external network via the power line; and
a power source unit which receives a power source supply via the power line and supplies the power source to the communication unit.

4. The wireless LAN system according to claim 2, characterized in that the wireless LAN access point comprises:
a communication unit including a wireless communication unit which performs wireless communication with the wireless LAN client terminal and also performs wireless communication with the external network or a router connected to the external network; and
a power source unit which receives a power source supply via the power line and supplies the power source to the communication unit.

5. The wireless LAN system according to claim 2, characterized in that the wireless LAN access point comprises:
a communication unit including a wireless communication unit which performs wireless communication with the wireless LAN client terminal and a network communication unit which performs network communication with the external network or a router connected to the external network via a network cable; and
a power source unit which receives a power source supply via the power line and supplies the power source to the communication unit.

6. The wireless LAN system according to claim 3, characterized in that:
the wireless LAN system further comprises a power source state notification unit which is attached to the lighting apparatus to monitor the power source state of the lighting apparatus and notify the power source state to the wireless LAN access point; and
the power source unit controls a power source supply to the communication unit according to the power source state of the lighting apparatus notified from the power source state notification unit.

7. The wireless LAN system according to claim 3, characterized in that:
the wireless LAN system further comprises a person detection sensor which notifies a detection signal to the wireless LAN access point when detecting the presence of a person; and
the power source unit controls a power source supply to the communication unit according to whether or not the detection signal has been notified from the person detection sensor.

8. The wireless LAN system according to claim 3, characterized in that:
the wireless LAN system further comprises a sound sensor which notifies a detection signal to the wireless LAN access point when detecting a sound; and
the power source unit controls a power source supply to the communication unit according to whether or not the detection signal has been notified from the sound sensor.

9. A wireless LAN access point which performs wireless communication with a wireless LAN client terminal to connect the wireless LAN client terminal to an external network, the wireless LAN access point being characterized in that the wireless LAN access point is attached to a lighting apparatus.

10. The wireless LAN access point according to claim 9, characterized in that the wireless LAN access point receives a power source supply via a power line from which the lighting apparatus receives a power source supply.

11. The wireless LAN access point according to claim 10, characterized in comprising:
a communication unit including a wireless communication unit which performs wireless communication with the wireless LAN client terminal and a power line communication unit which performs power line communication with the external network or a router connected to the external network via the power line; and
a power source unit which receives a power source supply via the power line and supplies the power source to the communication unit.

12. The wireless LAN access point according to claim 10, characterized in comprising:
a communication unit including a wireless communication unit which performs wireless communication with the wireless LAN client terminal and also performs wireless communication with the external network or a router connected to the external network; and
a power source unit which receives a power source supply via the power line and supplies the power source to the communication unit.

13. The wireless LAN access point according to claim 10, characterized in comprising:
a communication unit including a wireless communication unit which performs wireless communication with the wireless LAN client terminal and a network communication unit which performs network communication with the external network or a router connected to the external network via a network cable; and
a power source unit which receives a power source supply via the power line and supplies the power source to the communication unit.

14. The wireless LAN access point according to claim 11, characterized in that the power source unit controls a power source supply to the communication unit according to notification from the outside.
